(19) United States
(12) Patent Application Publication
(10) Pub. No.: US 2005/0155830 A1
(43) Pub. Date: Jul. 21, 2005

(54) Multi-functional rolling apparatus

(76) Inventor: Yea Yen Huang, Tocheng City (TW)

Correspondence Address: TROXELL LAW OFFICE PLLC, 5205 LEESBURG PIKE, SUITE 1404, FALLS CHURCH, VA, 22041, US

(21) Appl. No.: 10/758,077

(22) Filed: Jan. 16, 2004

(51) Int. Cl. H02G 11/00

(52) U.S. Cl. 191/12.2 R

(57) ABSTRACT

The present invention provides a multi-functional rolling apparatus, it basically has a rolling box and possibly combines with other electronic devices like another rolling box or computer connecting ports, card reader units, power extending outlets, WLAN transmitters and networking video cameras to possess multi-function effects. The rolling part has the reed inside the rolling box and has a signal conducting cable on the outer winding, and the box bottom has an elastic buckle for pulling, fixing or retracting signal conductive cable without pushing buttons. The present invented case is capable of having a combinational rod to combine the attractor or magnet as an attracting accessory.

### FIELD OF THE INVENTION

A structural design of a multi-functional rolling apparatus, especially for two-way rolling and for combining with electronic devices like USB/PS2/1394/RJ45 outlets, card reader units, power extending outlets, cooling fans, WLAN transmitters, and networking video cameras, becomes a multi-functional rolling apparatus. Additionally, the apparatus bottom has an elastic buckle for pulling, fixing or retracting signal conductive cable without pushing buttons, and upon the apparatus there is a combinational rod to combine with the attractor or magnet as an attracting accessory.

### BACKGROUND OF THE INVENTION

The birth and popularization of the PC has indeed been convenient for human beings; it significantly changed the usual working process. Furthermore, the continuous innovation of PC technology constantly increases related functions, therefore, PC related peripherals are continuously extended. Additionally, the latest growth of local area network has made many PC related peripherals, portable computers, personal computers and servers have complicated vertical, horizontal, serial and parallel connecting issues.

PC peripherals, such as Printers, Scanners, Video Monitors, Outer Disk Drivers, Keyboards, Mice, Modems, Card Readers, Digital Cameras, Outer Box and HUB devices, no matter what their size is, need connecting cables or connecting auxiliary devices to connect to the host to function. So computer makers are devoted to exploring how to connect these devices to the host or related operating system in the best way, and intend to supply demanding power, besides signal transmission, during connection.

Consequently, the PC engineering field develops Universal Serial Bus (USB), IEEE 1394 (6 lines), PS2 and RJ45 connectors, outlets or connecting ports of the connecting system. The system properly resolves connecting issues for PC related products, and it plays as the connecting bridge between the computer host and its peripherals. The maximum function of connecting systems of USB, 1394, PS2 and RJ45 make many computers or major peripherals connect to the computer host by gathering into the hub or the connecting port; it really solves the connecting issue of the PC and its peripherals and also the power supply.

The significant feature of connecting systems of USB, 1394, PS2 and RJ45 is that it comprises 4 to multiple lines; some are signal lines for data transmission, others are power lines for low voltage supply (ex. 5 volt) and for low current supply (ex. 100 mA˜500 mA), and another one is a ground line. Accordingly, the USB, 1394, PS2 and RJ45 connecting apparatus possess single data transmission or both data transmission and power supply.

USB, 1394, PS2 and RJ45 connecting outlets and plugs have been commonly installed in computer hosts, portable computers and HUB to make connection and transfer more universal and convenient.

According to the above, medium power lines or signal lines for connecting to equipment are constantly increased; furthermore, technicians for the job usually use different line materials, for instance, computer connecting lines for the computer user, communication connecting lines for the communication user and so on. In order to provide convenience for the user to carry or avoid complicated connection in use, the rolling box of the signal power line for the computer equipment is therefore produced.

The usual rolling box for gathering is only for gathering lines, its structure has a rolling reed inside the box to wind the line into the box, and has a buckle inside the box to gather the line into the box by the reed's tension while pushing the button, its function is similar to the commonly used rolling ruler.

Based on the simple function of the used rolling box, the inventor attempts to increase using functions for the rolling box to enhance the convenience and economy for usage, and finally created the multi-functional rolling apparatus after development. This apparatus basically has a rolling box to connect to another rolling box or computer connecting ports, connectors, card readers, cooling fans, WLAN and other electronic devices to possess multi-functions.

The present invented rolling part has a reed inside the rolling box and has a signal conducting cable on outer winding, and the box bottom has an elastic buckle for pulling, fixing or retracting signal conductive cable without pushing buttons.

The present invented rolling part is also applied to usual DC or AC power extending lines and upon the box there is a combinational rod to combine with the attractor or magnet as an attracting accessory.

### SUMMARY OF THE INVENTION

A structural design of a multi-functional rolling apparatus, especially for two-way rolling and for combining with the electronic devices like USB/PS2/1394/RJ45 outlets, card reader units, power extending outlets, cooling fans, WLAN transmitters, LAN HUB, ADSL sharing, and networking video cameras, becomes a multi-functional rolling apparatus. Additionally, the box bottom has an elastic buckle for pulling, fixing or retracting signal conductive cable without pushing buttons, and upon the case having a combinational rod to combine with the attractor or magnet as an attracting accessory.

### DESCRIPTION OF THE EMBODIMENT

As FIG. 1 and FIG. 2 show, the present invented multi-functional rolling apparatus mainly comprises top lid 1, sealing shell 2, rotating plate 3, bottom stand 4, reed 5, signal power line 6 and elastic buckle 7.

The present invented rolling mechanism is basically equipped inside the bottom stand 4, and has a hole 46 for withdrawing signal power line 6 on the outer top side. Referring to FIG. 1, FIG. 2, FIG. 3 and FIG. 12, top lid 1 has the symmetric screw 11 and a PCB 12 fixed inside. The outer edge of PCB 12 nearby lid edge has some USB outlets 13 and power input terminal 14.

Referring to FIG. 5 and FIG. 13, the PCB 12 is capable of equipping with a card reader stand 15 to make the present invention be a card reader for connecting to a PC or notebook at anytime.

Referring to FIG. 6 and FIG. 16, the PCB 12 has a power outlet 16 of usual DC or AC power, it is obviously necessary to modify signal power line 6 into a flat power line 6A with a plug 61A on the end.

Referring to FIG. 7, the present invented structure is capable of being used as a rolling box in bottom stand 4, and has a cooling fan 17 to connect one terminal of the signal power line 6 to the motor of cooling fan 17 and drives the motor by USB power supply in practice.

Referring to FIG. 8, the present invented structure is capable of being used as a rolling box in bottom stand 4, and has a WLAN transmitter 18 to accordingly create useful transmission equipment for the computer communication.

Referring to FIG. 9, the present invented structure is capable of being used as a rolling box in bottom stand 4, and has a networking video camera 19.

Referring to FIG. 11, the present invention is capable of combining two bottom stand 4 and 4A according to the present invented structure to use the same signal power line 6 and becomes a twin rolling box for individual withdrawing or gathering signal power line 6.

The present invented structure, as shown in FIG. 1 and FIG. 2, has a sealing shell 2 centered on an empty space beneath top lid 1, it is capable of combining top lid 1.

Referring to FIG. 1, FIG. 2 and FIG. 3, the present invented rotating plate 3 has a circular recess 31 on the center, this circular recess 31 has a through hole 32 on its center and a symmetric buckle 33 on the outer edge, one side of the buckle 33 has a symmetric oblique awl 34. The face of rotating plate 3 has a recess 35 and there is a screw outlet 36 in corresponding position.

The circular recess 31 of rotating plate 3 stated above has a reed 5 inside and is capable of winding signal power line 6 outside the protrusion of the back.

Referring to FIG. 1, FIG. 2, FIG. 3 and FIG. 17, the present invented bottom stand 4 has a flange 41 inside the top edge and centers a cylinder 42 with bearing 43 on its one side and a slot 44. The inner bottom of bottom stand 4 has a recess 45 and a hole 46 for withdrawing signal power line 6 outside.

Comparing both FIG. 19 and FIG. 20, it is capable of having a combinational rod 47 on the outer center of the above top lid 4 in necessity. The centered axis of combinational rod 47 has a screw thread hole 48 inside, it is capable of combining with screw rods of plastic attracting plate or magnet attracting plate prior applied by the inventor of R.O.C. 092215445, CN 032090242, JP 2003-271463, U.S. Ser. No. 10/658,329 and GM 203153316 subject of [symbol] Multi-Function Hanging and Fastening Device [symbol] patterns to attract the present invented multi-functional rolling apparatus on the glass or metal plate for usage.

Referring to FIG. 1, FIG. 2, FIG. 3, FIG. 15, FIG. 16, FIG. 19 and FIG. 20, the present invention has an elastic buckle 7 inside the recess 45 of the inner bottom of the above top lid 4 and a fastener recess 71 on one side. The elastic buckle 7 has an elliptic hole 72 and a square hole 73 and covers a prick wheel 74 on the top, and with a hole 75 and a rectangular protrusion 76 beneath.

One terminal of the above signal power line 6 connects to the PCB 12, the end drawing away from the rolling box has a USB connector 61 corresponding to USB connecting outlet 13 on top lid 1. The present invented USB connecting outlet 13 and corresponding USB connector 61 are capable of changing to PS2, 1394 and RJ45 corresponding connecting outlets and connectors of computers and communications.

### BRIEF DESCRIPTION OF DRAWINGS

FIG. 1 is the exploded perspective figure of each component of the present invented multi-functional rolling apparatus;

FIG. 2 is the exploded cross-section figure of each component of the present invented multi-functional rolling apparatus;

FIG. 3 is the combinational cross-section figure of each component of the present invented multi-functional rolling apparatus;

FIG. 4 is the perspective figure of the present invented multi-functional rolling apparatus having a USB connecting outlet;

FIG. 5 is the perspective figure of another embodiment having the card reader of the present invented multi-functional rolling apparatus;

FIG. 6 is the perspective figure of another embodiment having the card reader of the present invented multi-functional rolling apparatus;

FIG. 7 is the perspective figure of another embodiment having an usual extending outlet of the present invented multi-functional rolling apparatus;

FIG. 8 is the perspective figure of another embodiment having WLAN transmitter of the present invention;

FIG. 9 is the perspective figure of another embodiment having networking video camera of the present invention;

FIG. 10 is the perspective figure of another embodiment having two rolling boxes of the present invented multi-functional rolling apparatus;

FIG. 11 is the present invented embodiment printing MSK and CGS size marks on the flat signal power line or flat power line in order to be a simple ruler;

FIG. 12 is the structural perspective planar figure of the present invented FIG. 4;

FIG. 13 is the structural perspective planar figure of the present invented FIG. 5;

FIG. 14 is the structural perspective planar figure of the present invented FIG. 6;

FIG. 15 is the perspective figure of the present invented accessory elastic fastener;

FIG. 16 is the back perspective figure of the present invented accessory prick wheel;

FIG. 17 is the cross-section figure of the present invented accessory bottom stand;

FIG. 18 is the cross-section figure of the present invented accessory bottom stand having a combinational rod;

FIG. 19 is the comprehensive figure of the present invented accessory elastic fastener and prick wheel action; and

FIG. 20 is the comprehensive figure of the present invented accessory elastic fastener and another action of the prick wheel.

FIG. 21 is the top-view figure of the bottom stand of another embodiment of the present invented rolling box;

FIG. 22 is the perspective figure of the present invented FIG. 21;

FIG. 23 is the top-view figure of the rotating plate of another embodiment of the present invented rolling box;

FIG. 24 is the perspective figure of the present invented FIG. 23;

FIG. 25 is the top-view figure of the prick wheel of another embodiment of the present invented rolling box;

FIG. 26 is the perspective figure of the present invented FIG. 25;

FIG. 27 is the comprehensive figure of another embodiment of the present invented rolling box;

FIG. 28 is the top-view figure of the bottom stand of another embodiment of the present invented rolling box;

FIG. 29 is the perspective figure of the present invented FIG. 28;

FIG. 30 is the top-view figure of the rotating plate of another embodiment of the present invented rolling box;

FIG. 31 is the perspective figure of the present invented FIG. 30;

FIG. 32 is the top-view figure of the elastic buckle and prick wheel of another embodiment of the present invented rolling box;

FIG. 33 is the perspective figure of the present invented FIG. 32; and

FIG. 34 is the comprehensive figure of another embodiment of the present invented rolling box.

### DESCRIPTION OF THE PREFERRED EMBODIMENT

Based on the above structure, the present invention will put elastic buckle 7 inside the recess 45 of bottom stand 4 during installation, and then cover the bearing 43 by the hole 75 on the top of the prick wheel 74. The signal power line 6 is wound on the outside of the back protrusion of circular recess 31 of the above rotating plate 3, its one terminal is drawn from the hole 46 of the bottom stand 4 with USB connector 61 on the end, the other terminal passes through the recess 35 of rotating plate 3 to connect to the PCB 12 of top lid 1.

The rotating plate 3 having wound signal power line 6 and fixed reed 5 covers the cylinder 42 centered bottom stand 4 by passing through the through hole 32 centered on circular recess 31 and is fixed inside the buckle protrusion 41 of bottom stand 4 to combine the rotating plate 3 with the bottom stand 4 with rotating status for both.

Using the screw 16 screws the hole 11 of top lid 1 into the screw thread 36 of rotating plate 3 to combine top lid 1, sealing shell 2 and rotating 3.

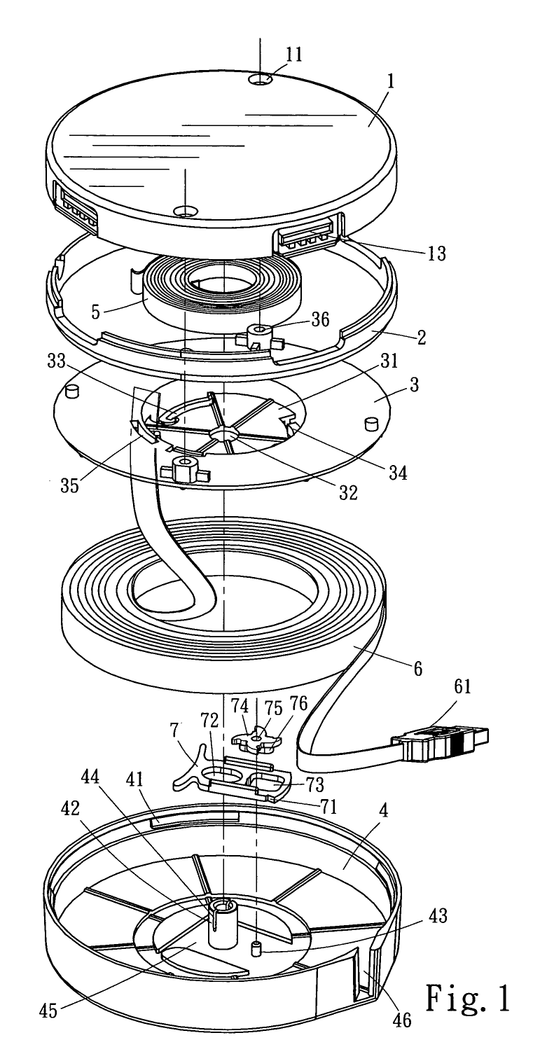

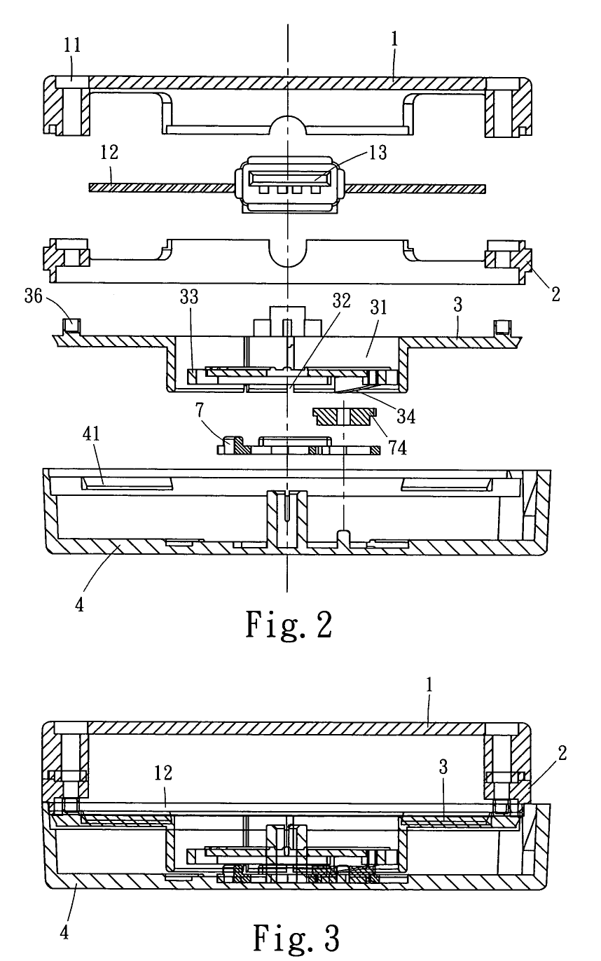

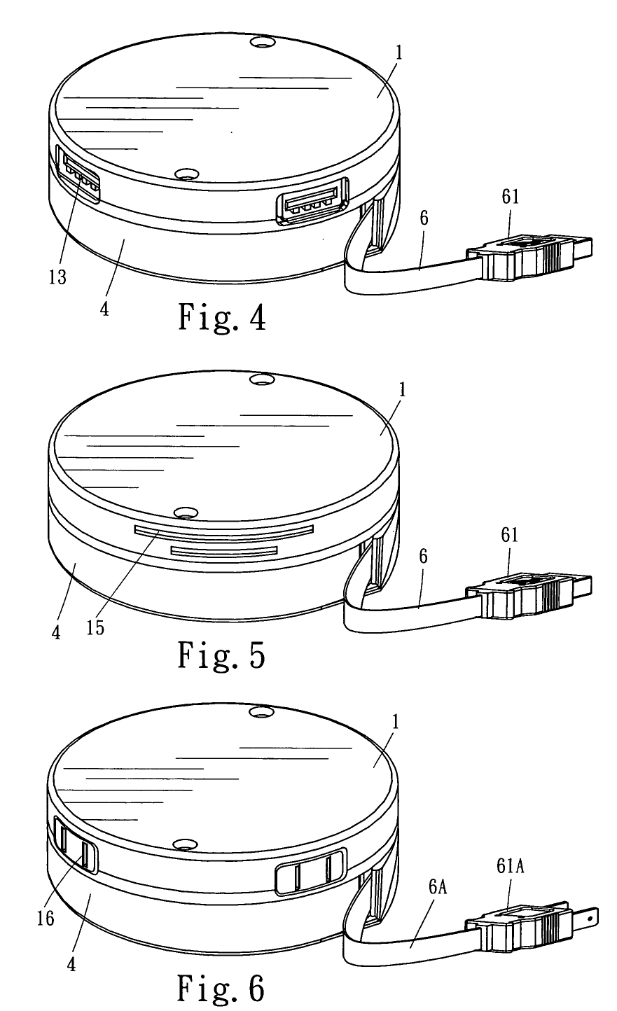

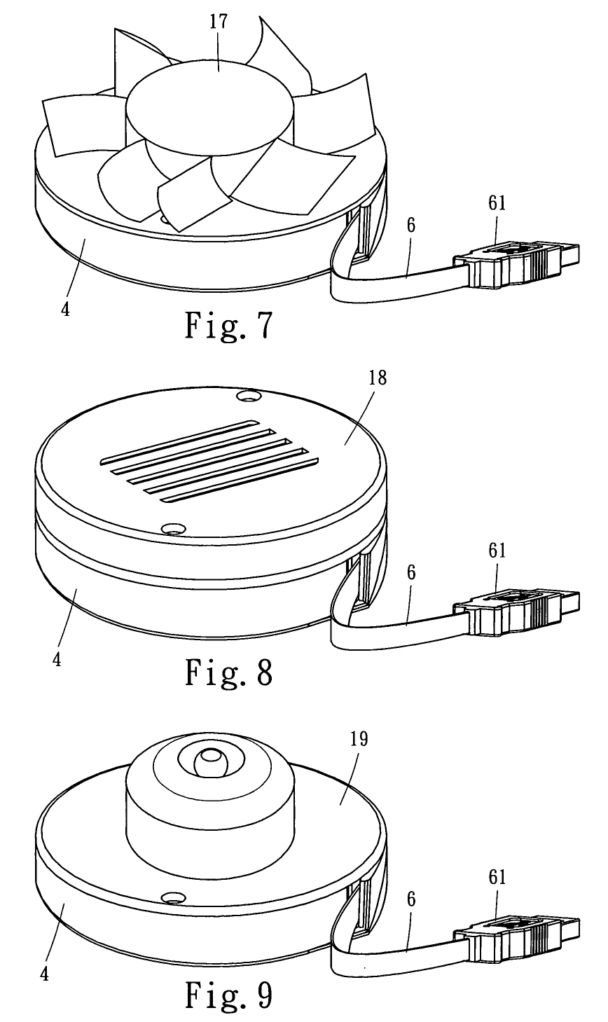

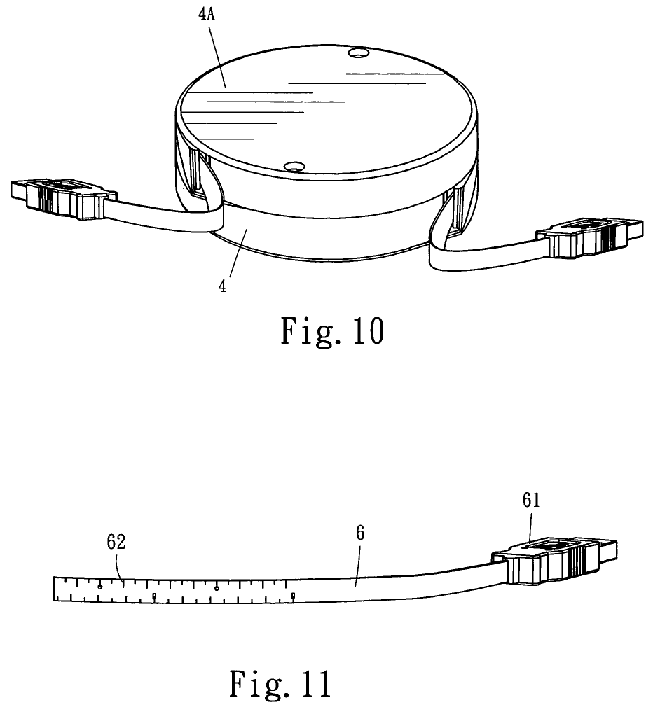

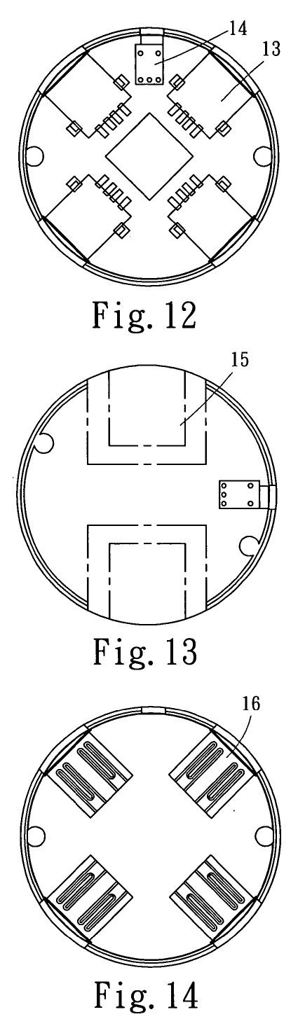

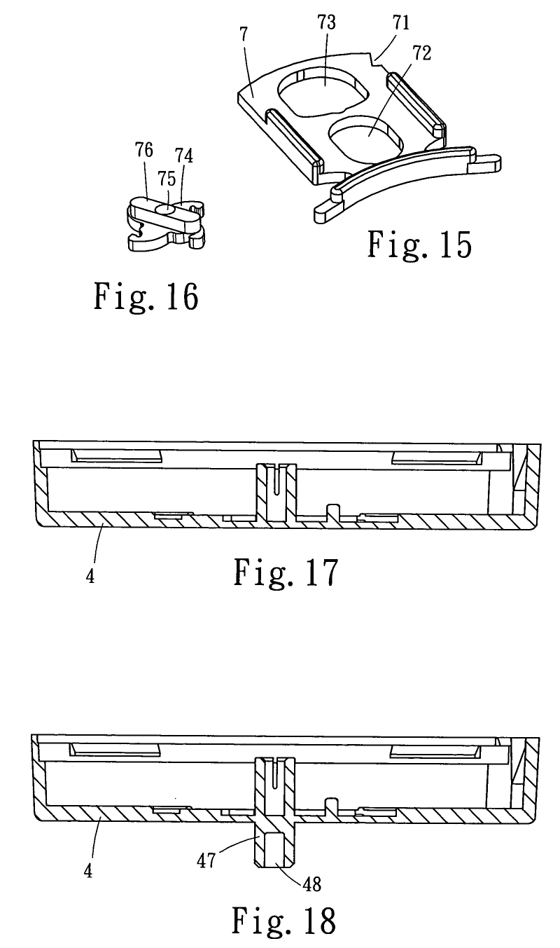

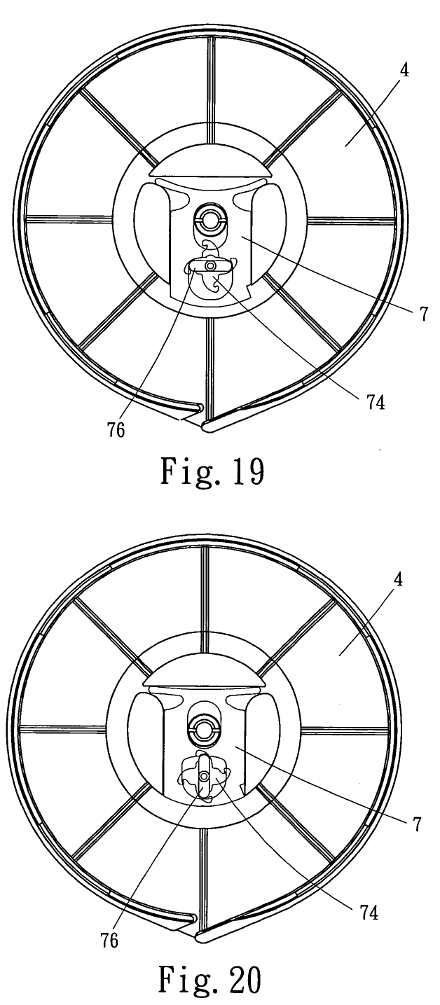

Referring to FIG. 1, FIG. 2, FIG. 3, FIG. 15, FIG. 16, FIG. 19 and FIG. 20 of the present invented multi-functional rolling apparatus, its rolling part has no need to add buttons for pulling or retracing controlled signal power line 6. Referring to FIG. 19 and FIG. 20, the user pulls the first time (withdrawing signal power line 6) as soon as rotating the rotating plate 3, and the buckle 33 stirs the prick wheel 7 until the rotation ceases to make the rectangular protrusion 76 of the prick wheel 74 horizontal. In case of being non-horizontal, slight pulling will make elastic buckle 7 backward (the forward and backward is moved between cylinders 42 by elliptic hole 72), and make the cross-section of oblique awl 34 of the circular recess 31 of rotating plate 3 fix on buckle recess 71 of one side of the elastic buckle 7 to cease rotation of rotating plate 3, that is, signal power line 6 will stop without retrace.

Following the user, slightly pulling signal power line 6 will rotate prick wheel 90 degrees to be vertical for rectangular protrusion 76. Its terminal props the front side of rectangular hole 73 to make elastic buckle 7 forward and separates the recess 71 of the elastic buckle 7 away from the buckle of the awl 34 of the rotating plate 3 in order to drive the rotating plate 3 by the tension of the reed 5 to wind and gather the signal power line 6 into the box.

Referring to FIG. 11, the present invented flat signal power line 6 or flat power line 6A are capable of printed MKS and CGS size marks 62 in practice for the user to be a simple ruler.

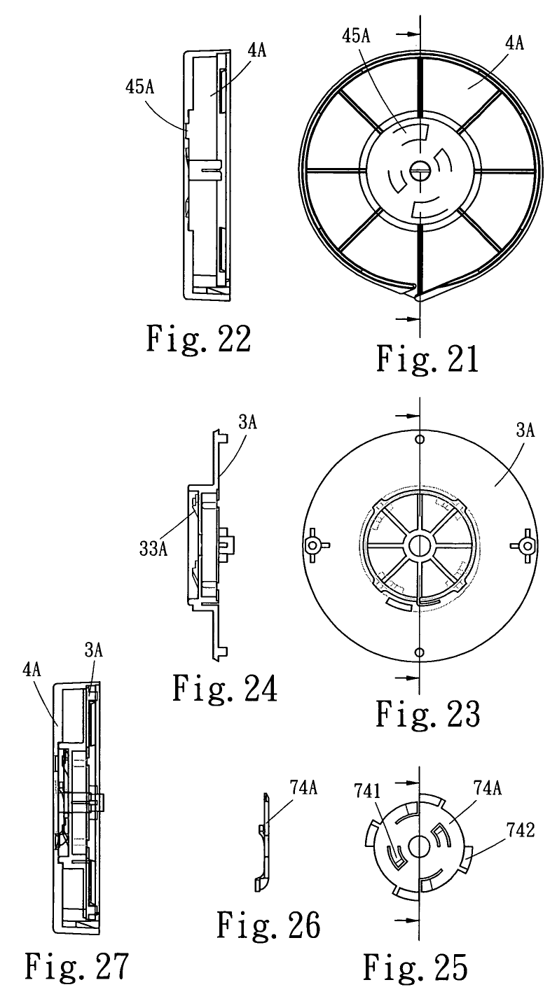

Referring to FIG. 21 to FIG. 27, another embodiment of the control part of the present invented rolling apparatus is capable of omitting the original elastic buckle 7 by using a prick wheel 74A and its elastic wedge 741 on the side and protrusion 742 to match to a bottom stand 4A of the symmetric wedge recess 45A and similarly has a rotating plate 3A of the oblique buckle 33A symmetric to the protrusion 743 in order to accordingly accomplish the withdrawing or retracing controlled function for the signal power line 6 without pushing buttons.

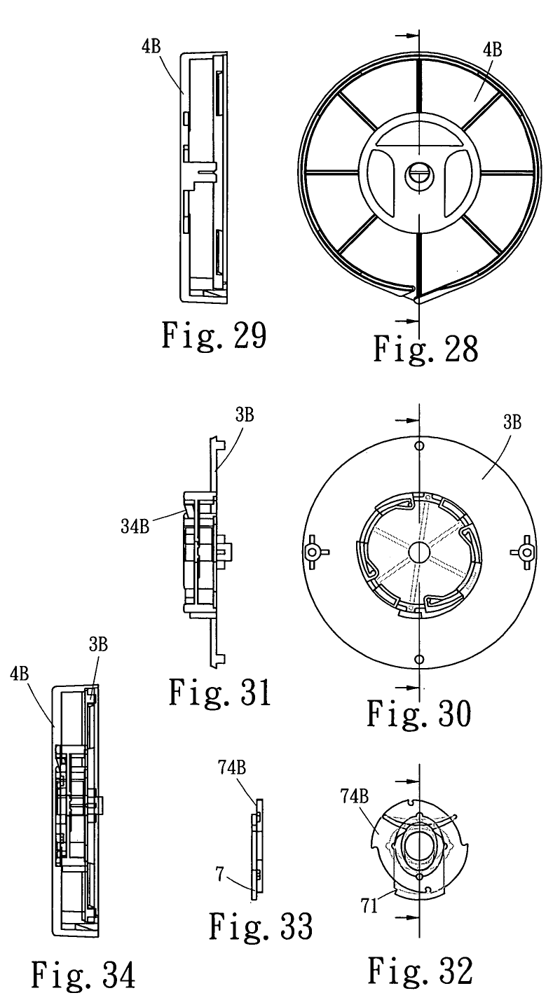

Referring to FIG. 28 to FIG. 34, another embodiment of the control part of the present invented rolling apparatus is capable of enlarging the original prick wheel 74 and shaped an elliptic prick wheel 74B, by means of the length-width difference of the elliptic prick wheel 74B to control the forward and backward movement of the elastic buckle 7, similarly by means of the symmetric rotating plate 3B and bottom stand 4B to make the oblique awl 34B fix the buckle recess 71 during the backward placement of the elastic buckle 7 to accordingly accomplish the withdrawing or retracing controlled function for the signal power line 6 without pushing buttons.

1. A multi-functional rolling apparatus, its structure comprises a top lid, sealing shell, rotating plate, bottom stand, reed, signal power line and elastic buckle, and characterized in that the rolling apparatus of the bottom stand is capable of connecting to the top lid's electronic devices like USB connecting outlets, card reader units, power extending outlets, cooling fans, WLAN transmitters, LAN HUB, ADSL sharing and networking video cameras to become a multi-functional rolling apparatus.

2. A multi-functional rolling apparatus in accordance with claim 1, wherein the outer side of the bottom stand has a drawing hole for signal power line, there is fixed a PCB inside top lid and has one to many USB connecting outlets or power input ports on the PCB edge near the box.

3. A multi-functional rolling apparatus in accordance with claim 1, wherein there is a recess in the rotating plate and has a reed inside, the signal power line wound on the outside of the protrusion on the recess back is drawn from the hole of the bottom stand on one terminal having a USB connector on the end, the other terminal passes through the recess of the rotating plate and connects to the PCB of the top lid, the outer side of the recess of the rotating plate has a symmetric buckle and a symmetric oblique awl on one side of the buckle.

4. A multi-functional rolling apparatus in accordance with claim 1, wherein the USB connecting outlet and corresponding USB connector are capable of changing to PS2, 1394 and RJ45 corresponding connecting outlets and connectors for computers and communications.

5. A multi-functional rolling apparatus in accordance with claim 1, wherein the PCB inside top lid is capable of having card reader outlet.

6. A multi-functional rolling apparatus in accordance with claim 1, wherein the PCB of top lid is capable of having the usual DC or AC power outlet and changes the signal power line to a flat power line with the plug on the end.

7. A multi-functional rolling apparatus in accordance with claim 1, wherein it is possible to use only the rolling box of the bottom stand, there is a cooling fan on the top and connects one terminal of the signal power line to the motor of the cooling fan.

8. A multi-functional rolling apparatus in accordance with claim 1, wherein the PCB inside top lid is capable of having a WLAN transmitter, WLAN HUB or broadband ADSL sharing to accordingly create useful equipment for the computer communication.

9. A multi-functional rolling apparatus in accordance with claim 1, wherein the PCB inside the top lid is capable of having a networking video camera;

10. A multi-functional rolling apparatus in accordance with claim 1, wherein it is possible to combine two rolling boxes of the bottom stand to use only one signal line to become a twin rolling box for individual withdrawing or gathering signal power line.

11. A multi-functional rolling apparatus in accordance with claim 1, wherein there is a recess on the bottom of the bottom stand and an elastic buckle inside, there is a buckle recess on one side and an elliptic hole and a square hole on the elastic buckle, it is possible to cover into a prick wheel and there is a hole on the top, the position facing down has a rectangular protrusion to rotate the rotating plate as soon as signal power line is pulled, and the buckle will stir the prick wheel to make the rectangular protrusion of the prick wheel horizontal in order to move the elastic buckle backward and make the oblique awl of the recess of rotating plate fix the recess of one side of the elastic buckle to cease rotating plate, the rotating plate stop will cease signal power line to retrace, in case of slightly pulling by the user, the signal power line will rotate the prick wheel 90 degrees to make the rectangular protrusion vertical, the terminal props the front side of the rectangular hole to forward the elastic buckle and separate the recess of the elastic buckle away from the oblique awl of the rotating plate, and the rotating plate is driven by the tension of the reed to wind and gathers a signal power line inside the box, the present invented rolling part is accordingly possible to control withdrawing and retracing of the signal power line without having additional control.

12. A multi-functional rolling apparatus in accordance with claim 1, wherein the outer center of the bottom stand is capable of having a combinational rod in necessity, there is a screw thread hole inside the central axis of the combinational rod, it is capable of screwing with the screw of plastic attracting plate or magnet attracting plate to attract the multi-functions of rolling, reading and connecting port to the glass or metal plate for usage.

13. A multi-functional rolling apparatus in accordance with claim 1, wherein it is possible to print MKS and CGS size marks on the flat signal power line for the user to have a simple ruler.

14. A multi-functional rolling apparatus in accordance with claim 1, wherein the control part of the rolling apparatus is capable of omitting the original elastic buckle by using a prick wheel and its elastic wedge on the side and protrusion to match to a bottom stand of the symmetric wedge recess and similarly has a rotating plate (3A) of the oblique buckle (33A) symmetric to the protrusion (743) in order to accordingly accomplish the withdrawing or retracing controlled function for the signal power line without pushing buttons

15. A multi-functional rolling apparatus in accordance with claim 1, wherein the control part of the rolling apparatus is capable of enlarging the original prick wheel and shaped an elliptic prick wheel, by means of the length-width difference of the elliptic prick wheel to control the forward and backward movement of the elastic buckle, similarly by means of the symmetric rotating plate and bottom stand to make the oblique awl fix the buckle recess during the backward of the elastic buckle to accordingly accomplish the withdrawing or retracing controlled function for the signal power line without pushing buttons.
